(19) United States
(12) Patent Application Publication
(10) Pub. No.: US 2010/0287594 A1
(43) Pub. Date: Nov. 11, 2010

(54) SYSTEM FOR IMPLEMENTING MOBILE TELEVISION IN WIRELESS TERMINAL

(75) Inventor: Xuejun Zhang, Shanghai (CN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/811,290

(22) PCT Filed: Dec. 26, 2008
(86) PCT No.: PCT/IB08/55548

§ 371 Date: Jun. 30, 2010

(30) Foreign Application Priority Data
Jan. 3, 2008 (US) 61018741
Dec. 26, 2008 (IB) PCT/IB2008/055548

(51) Int. Cl. H04N 7/16; H04W 88/02

(52) U.S. Cl. 725/62; 455/550.1

(57) ABSTRACT

A multi-modular terminal device enables simultaneous communications over multiple wireless networks. The terminal device includes a cellular module and a Mobile TV module. The cellular module includes a dual-band transceiver, a first duplexer for duplexing receive and transmit signals in a first band, a filter for filtering receive signals in a second band, a dual-band power amplifier for amplifying transmit signals in the first band and the second band, and at least one first antenna for communicating signals in the first band and the second band of the first module. The Mobile TV module includes a Mobile TV receiver for receiving receive signals in a Mobile TV band and a second antenna for communicating signals in the Mobile TV band. The first duplexer reduces inter-module interference in the Mobile TV band caused by at least the transmit signals of the first band.

The present application is related to U.S. Provisional Patent Application 60/986,936, entitled “System for Implementing Multi-Modular Standby Terminal using Duplexers,” filed Nov. 9, 2007, and U.S. Provisional Patent Application 60/986,941, entitled “System for Implementing Multi-Modular Standby Terminal using Filters,” filed Nov. 9, 2007, the subject matters of which are specifically incorporated herein by reference.

As the demand for wireless communications increases, customers more frequently subscribe to multiple services, including services corresponding to different types of wireless networks. Accordingly, cellular devices, have been provided that are capable of handling communications over multiple types of wireless networks. For example, a mobile wireless terminal, such as a cellular phone, a PDA or a laptop computer, may access multiple cellular networks, such as Global System for Mobile communications (GSM) and Wideband Code Division Multiple Access (W-CDMA) communications systems.

Similarly, wireless terminals may include Mobile TV capability, providing television services over wireless communication networks, in addition to conventional mobile voice and data communication services. Mobile TV may provide traditional television programming, live broadcasting, video on demand and the like, and enable customers to personalize their services. Mobile TV may be implemented over two-way cellular networks and/or one-way broadcast networks, such as digital video broadcasting-handheld (DVB-H), digital video broadcasting-terrestrial (DVB-T), digital multimedia broadcasting (DMB), and TDtv networks, for example.

If noise produced by a terminal transmitter reaches a simultaneously operating receiver in the same terminal at a strong enough level and at the frequency of operation of the receiver, it can degrade the signal-to-noise ratio of that receiver (“desense” that receiver), decreasing the ability of that receiver to accurately receive information.

However, it is difficult to coordinate operations of a cellular module and a Mobile TV module in a terminal. A terminal that operates in a Time Division Multiple Access (TDMA) environment, for example, would have to simultaneously transmit for the cellular module and receive for the Mobile TV module, leading to significant radio frequency (RF) interference to the Mobile TV module.

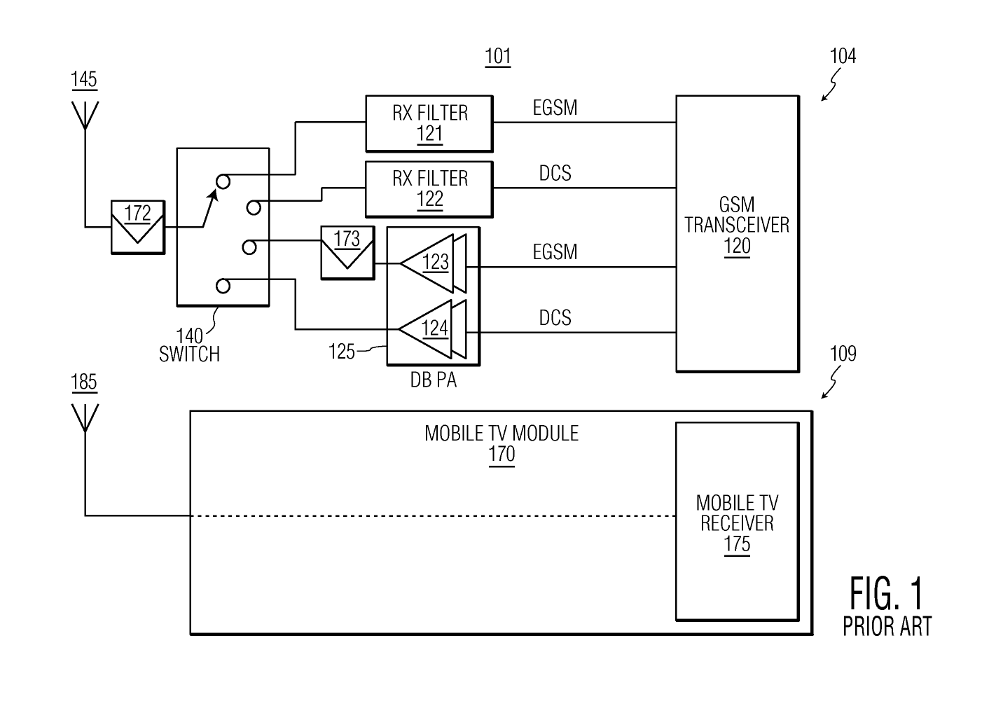

FIG. 1 depicts a conventional terminal including wireless Mobile TV functionality. A first module has a first RF front-end 104, which includes a GSM transceiver 120 capable of receiving and transmitting on multiple frequency bands, such as an extended GSM (EGSM) band, a Digital Communication System (DCS) band, a Personal Communications Services (PCS) band, or the like. For purposes of explanation, a first band is shown as an EGSM band and a second band is shown as a DCS band. A second module is a Mobile TV module 170, which has an RF front-end 109. The RF front-end 109 includes at least a Mobile TV receiver 175 and an antenna 185 for Mobile TV reception and/or transmission.

The cellular module front-end 104 includes a dual band power amplifier 125 having power amplifiers 123, 124 for amplifying transmit signals for two separate bands, and receive filters 121, 122 for filtering receive signals for two separate bands. Antenna switch 140 selectively connects the first GSM transceiver 120 to the antenna 145 through one of the transmit power amplifiers 123, 124 or the receive filters 121, 122, depending on the frequency band and on whether the antenna 145 is sending or receiving signals. The antenna switch 140 may be a single-pole four throw (SP4T), which combines the bands to the single antenna 145 and serves as a transmit/receive (T/R) switch for each band.

With respect to Mobile TV module front-end 109, the Mobile TV receiver 175 may operate in a variety of spectrums, including TV band III (174 MHz to 230 MHz) and TV bands IV and V (470 MHz to 862 MHz). TV bands III, IV and V include digital and analog TV channels. TV bands IV and V are particularly close to the GSM transmission band (880 MHz to 915 MHz). Therefore, transmissions from the GSM transceiver 120 may interfere with reception of the Mobile TV receiver 175. Accordingly, a Mobile TV band (e.g., DVB-H band) rejection filter 172 or 173 is included in the RF front-end 104 to prevent GSM interference. For example, TV band rejection filter 172 may be included between the antenna 145 and the switch 140, or the TV band rejection filter 173 may be included between the switch 140 and the power amplifier 125. However, the TV band rejection filter 172 will introduce extra insertion loss for the DCS band, and the TV band rejection filter 173 typically has limited attenuation on the GSM band.

Thus, when a Mobile TV module is included in a cellular handset, for example, the transmissions of the cellular module are in the neighborhood of the receptions of the Mobile TV module. In this case, signals may pass through components necessary for transmission in the cellular module, and reach the receiver of the Mobile TV module, resulting in “desensing” of the receiver of the Mobile TV module.

In accordance with an illustrative embodiment, a multi-modular device enables simultaneous communications over multiple wireless networks. The terminal device includes a duplexer and first and second antennas. The duplexer is connected to a first transceiver corresponding to a first wireless network of the multiple wireless networks. The first antenna is connected to the first duplexer for receiving and sending first signals to and from the first transceiver. The second antenna is connected to a second receiver corresponding to a second wireless network for receiving second signals to the second receiver. The duplexer reduces interference to the second signals caused by the receiving and sending of the first signals.

The second receiver may be a Mobile TV receiver and the second signals may be Mobile TV signals. The Mobile TV signals may include one of digital video broadcasting-handheld (DVB-H) signals or digital video broadcasting-terrestrial (DVB-T) signals, for example.

The first transceiver may include a dual-band GSM transceiver. A first band of the dual-band GSM transceiver may be an extended GSM (EGSM) band and the first signals may be EGSM signals. A second band of the dual-band GSM transceiver may be a Digital Communication System (DCS) band. The duplexer may filter the EGSM signals to reduce interference with the Mobile TV signals.

The terminal device may further include a power amplifier connected between the duplexer and the first transceiver. The power amplifier amplifies the first signals sent from the first transceiver for transmission over the first network. The duplexer may include a transmit filter for filtering the first signals received from the first power amplifier and a receive filter for filtering the first signals received from the first antenna.

In accordance with another illustrative embodiment, a terminal enables simultaneous communications over multiple wireless networks. The terminal includes first and second modules. The first module includes a dual-band transceiver, a duplexer for duplexing receive and transmit signals in a first band, a filter for filtering receive signals in a second band, a dual-band power amplifier for amplifying transmit signals in the first band and the second band, and at least one first antenna for communicating signals in the first band and the second band of the first module. The second module includes a Mobile TV receiver for receiving receive signals in a Mobile TV band and a second antenna for communicating signals in the Mobile TV band. The duplexer in the first module reduces inter-module interference in the Mobile TV band caused by at least the transmit signals of the first band.

The Mobile TV signals may be one of DVB-H or DVB-T signals. Further, the Mobile TV band may be a band within a range of 470 MHz to 862 MHz. With respect to the first module, the duplexer may include a transmit filter for attenuating noise in the first band, and thus preventing interference with at least receive signals in the Mobile TV band. The filter may be a surface acoustic wave (SAW) filter. Also, the wireless networks may be Time Division Multiple Access (TDMA) networks. The first band may be an EGSM band and the second band may be DCS band. The terminal may further include a transmit/receive switch for selectively connecting the receive and transmit signals in the EGSM band to the duplexer, the receive signals in the DCS band to the filter and the transmit signals in the DCS band to the dual-band power amplifier. The at least one first antenna may include an EGSM antenna for communicating signals in the EGSM band and a DCS antenna for communicating signals the DCS band.

In accordance with another illustrative embodiment, a system for communicating over wireless networks using a multi-modal terminal includes a Module TV module configured to communicate television signals in a Mobile TV band, and a GSM module configured to communicate EGSM signals in an EGSM band and DCS signals in a DCS band. The Mobile TV module includes a receiver and a Mobile TV antenna for receiving receive signals in the Mobile TV band. The GSM module includes a multi-band transceiver, a duplexer for duplexing transmit signals in the EGSM band, a dual-band power amplifier for amplifying transmit signals in the EGSM band and the DCS band, a GSM antenna for sending transmit signals in at least one of the EGSM band and the DCS band, and a switch for selectively connecting the duplexer to the GSM antenna for sending the transmit signals in the EGSM band and selectively connecting the power amplifier to the GSM antenna for sending the transmit signals in the DCS band. The duplexer attenuates noise caused by transmit signals in the EGSM band, reducing interference to receive signals in the Mobile TV band.

The representative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a block diagram illustrating a conventional cellular terminal, having a multi-band GSM cellular module and a mobile television module.

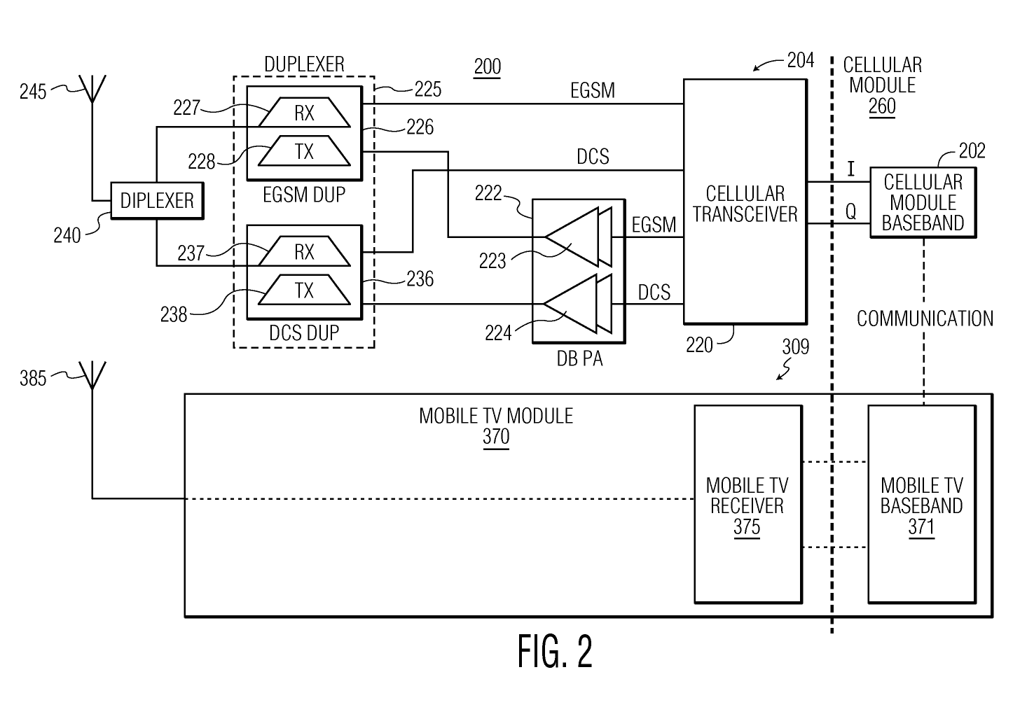

FIG. 2 is a block diagram illustrating a terminal having a cellular module and mobile television module, in accordance with a representative embodiment.

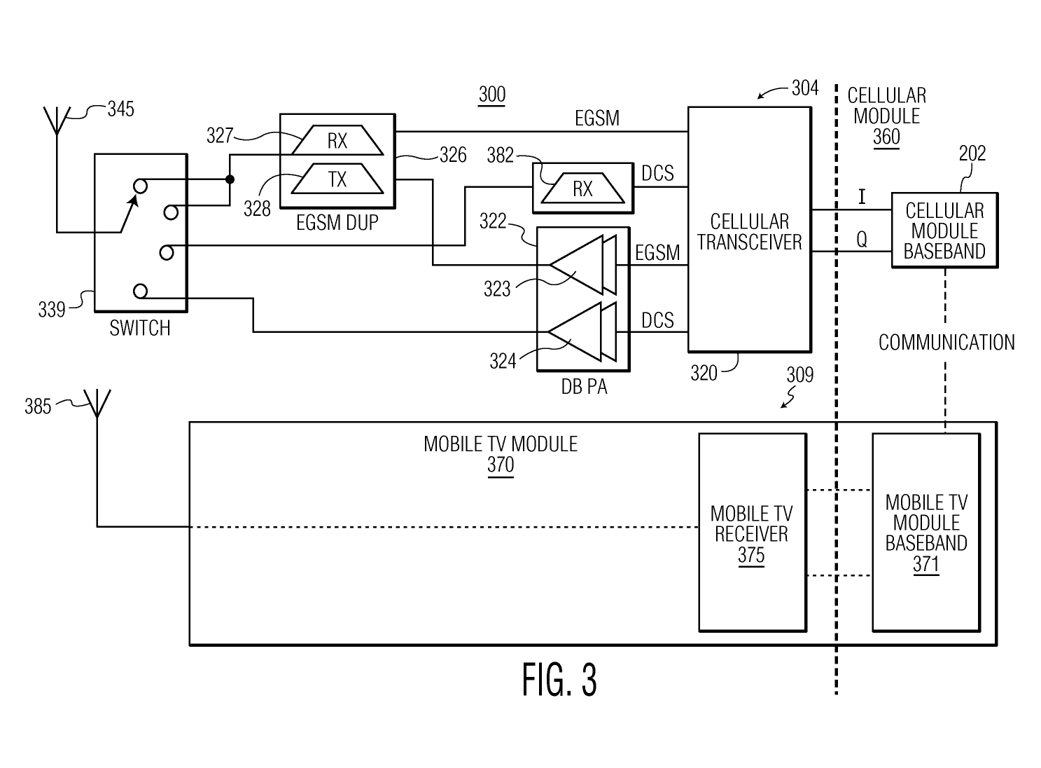

FIG. 3 is a block diagram illustrating a terminal, in accordance with another representative embodiment.

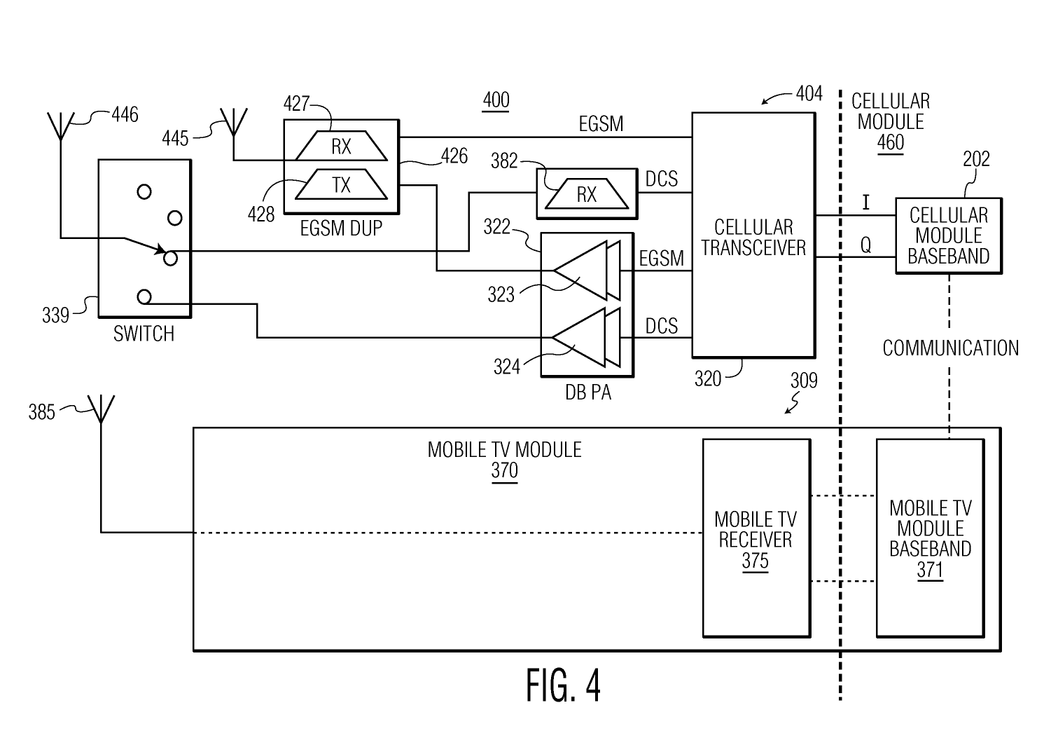

FIG. 4 is a block diagram illustrating a terminal, in accordance with another representative embodiment.

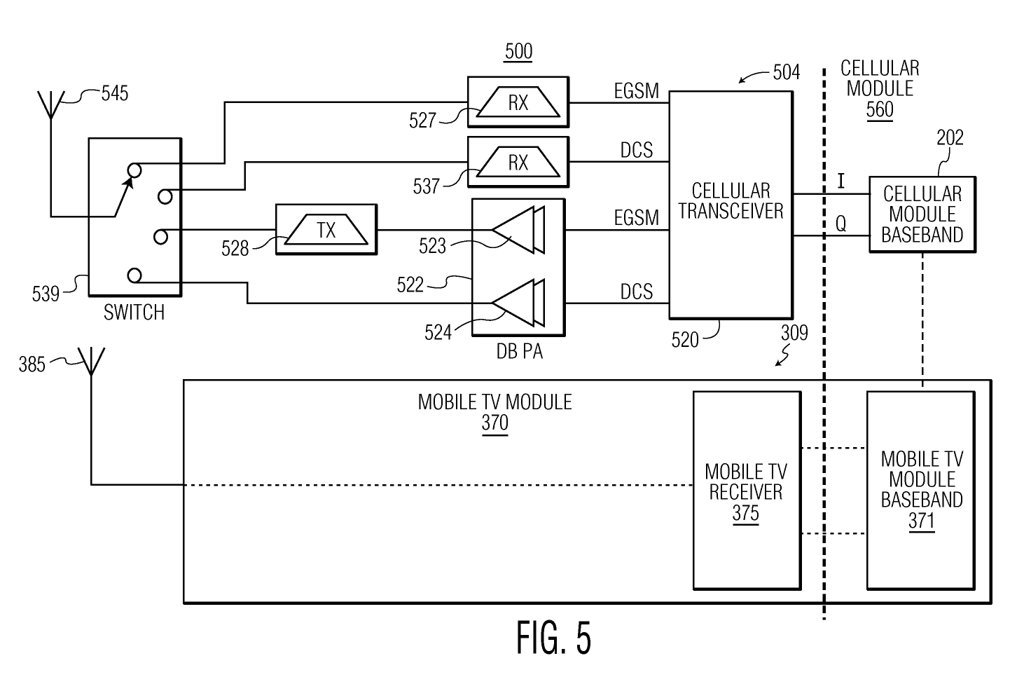

FIG. 5 is a block diagram illustrating a terminal, in accordance with another representative embodiment.

In the following detailed description, for purposes of explanation and not limitation, specific details are set forth in order to provide a thorough understanding of example embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of apparati, devices, materials and methods known to one of ordinary skill in the art may be omitted so as to not obscure the description of the example embodiments. Such apparati, devices, methods and materials are clearly within the scope of the present teachings.

FIG. 2 is a block diagram illustrating a cellular terminal 200 having a Mobile TV module, in accordance with a representative embodiment. The terminal 200 may be a TDMA wireless communications device operating in a GSM communications system, for example. As will be appreciated by those skilled in the art, one or more of the various “parts” shown in the figures may be physically implemented using a software-controlled microprocessor, hard-wired logic circuits, or combinations thereof. Also, while the parts are functionally segregated, for example, in FIG. 2, for explanation purposes, they may be combined variously in any physical implementation.

The terminal 200 includes two modules, Cellular Module 260 and Mobile TV Module 370, each of which operates on multiple frequency bands. Cellular Module 260 has a baseband 202 and an RF front-end 204, which communicate IQ symbols, for example, over corresponding I and Q paths. The IQ symbols represent digital voice and/or data from/to applications running one the terminal 200, although different formatting of the information to be transmitted/received may be incorporated, depending on the modulation scheme. Mobile TV Module 370 has a baseband 371 and an RF front-end 309. The Cellular Module baseband 202 and the Mobile TV Module baseband 371 may coordinate operations, and interface with the RF front-ends 204, 375, respectively, as well as with various applications of the wireless communications device through inter-module communications.

The RF front-end 204 of Cellular Module 260 includes multi-band transceiver 220 and the RF front-end 309 of Mobile TV Module 370 includes receiver (or transceiver) 375, which may be simultaneously operating with multi-band cellular transceiver 220 of the RF front-end 204. For purposes of explanation, the multi-band cellular transceiver 220 is shown to include an EGSM first band and a DCS second band. It is understood, however, that different types of frequency bands may be incorporated without departing from the spirit and scope of the various embodiments.

The RF front-end 204 further includes an antenna 245, a diplexer 240, a duplexer 225, and a dual band power amplifier 222. The duplexer 225 includes an EGSM duplexer 226 and a DCS duplexer 236, corresponding to the multiple bands of Cellular Module 260. Likewise, the dual band power amplifier 222 includes a first amplifier 223 for amplifying EGSM transmit signals and a second amplifier 224 for amplifying DCS transmit signals. The EGSM duplexer 226 includes a receive filter 227 and a transmit filter 228, and the DCS duplexer 236 includes a receive filter 237 and a transmit filter 238. Generally, the duplexer 225 enables the single antenna 245 to serve as both a receive antenna and a transmit antenna for each of the multiple bands (e.g., EGSM and DCS). The diplexer 240 separates signals to enable the antenna 245 to be shared in common by more than one band.

Referring to the RF front-end 204 of Cellular Module 260, transmit signals from the transceiver 220 are amplified by one of the EGSM first amplifier 223 or the DCS second amplifier 224 of the dual band power amplifier 222, and pass through one of the EGSM duplexer 226 or the DCS duplexer 236, depending on the band. The diplexer 234 then provides the transmit signals to the antenna 245 for transmission. Receive signals pass through the antenna 245, the diplexer 234, and one of the EGSM duplexer 226 or the DCS duplexer 236, depending on the band, to the transceiver 220.

The duplexers 226, 236 are used in place of an antenna switch (e.g., a T/R switch) in conventional systems, such as the T/R switch 140 or 180 of FIG. 1. The duplexers 226, 236 reduce inter-module RF interference, such as “desensing,” for example, between the cellular transceiver 220 and the Mobile TV receiver 375. As stated above, the duplexers 226, 236 respectively include the receive filters 227, 237 and the transmit filters 228, 238. The receive filters 227, 237 are situated between the antenna 245 and low noise amplifiers (LPAs) (not shown) corresponding to each of the EGSM and DCS band signal paths, respectively. The receive filters 227, 237 pass the received EGSM and DCS band signals with minimal attenuation, respectively, but provide high attenuation of signals generated in the transmission band. The transmit filters 228, 238 are situated between the antenna 245 and the power amplifiers 223, 224 of the dual band power amplifier 222 corresponding to the EGSM and DCS band signal paths, respectively. The transmit filters 228, 238 pass the transmitted EGSM and DCS band signals with minimal attenuation, respectively, but provide high attenuation of signals generated in, not only its own receive band, but also the receive band of Mobile TV band, e.g., to prevent “desensing.”

The functionally of Mobile TV Module 370 may be substantially the same as that of a traditional Mobile TV Module 370. Thus, explanation of its functionality will not be repeated. Further, the RF front-end 309 of Mobile TV Module 370 need only have a conventional configuration of filters, amplifiers, and the like, so they are not shown in the figures.

In accordance with the representative embodiment, Mobile TV Module 370 may receive signals on the neighboring bands simultaneously with Cellular Module 260 transmitting and receiving signals, without being negatively affected by inter-module interference. For example, the noise effects of transmitting interference are overcome when, for example, Mobile TV Module 370 is receiving a signal while Cellular Module 260 in the same terminal 200 is transmitting a signal. Further, the implementation is relatively simple, in that, in order to overcome the inter-module RF interference, Cellular Module 260 employs a duplexer instead of a T/R switch of a traditional GSM terminal. The duplexer is used to prevent the desensing of Mobile TV Module 370, for example, from the transmitter of Cellular Module 260.

FIG. 3 is a block diagram illustrating a cellular terminal 300 having a Mobile TV Module, in accordance with another representative embodiment. More particularly, FIG. 3 includes Cellular Module 360, and Mobile TV Module 370, which operates in a single Mobile TV band.

The RF front-end 304 of Cellular Module 360 requires only one duplexer, duplexer 326, for the EGSM band signals. Transmit signals from the transceiver 320 are amplified by one of the EGSM first amplifier 323 or the DCS second amplifier 324 of the dual band power amplifier 322, depending on the band. EGSM band signals then pass through the EGSM duplexer 326, including transmit filter 328, to the antenna switch 339, which may be a T/R switch. DCS band signals, however, are sent to the switch 339 without passing through a duplexer. The switch 339 selectively connects one of the EGSM band signal or the DCS band signal to the antenna 345 for transmission over the wireless network.

Signals received by the antenna 345 are passed to the switch 339. When the received signal is an EGSM band signal, the switch 339 connects to the EGSM duplexer 326. The EGSM band signal is then passed through the EGSM duplexer 326, including receive filter 327, to the transceiver 320. When the signal is a DCS band signal, the switch 339 connects to a separate filter, filter 382, and the DCS band signal is passed through the filter 382 to the transceiver 320, without passing through a duplexer. The filter 382 may be a surface acoustic wave (SAW) filter, for example, although it is not limited to such a configuration.

Although depicted separately, it is understood that the various combinations of components may be implemented as a single chipset, e.g., to save cost and space, with respect to each of the various embodiments described herein. For example, the antenna switch 339 may be combined into a chip set with the antenna 345, the power amplifier 322 and/or the filter 382.

Referring to the RF front-end 309 of Mobile TV Module 370, Mobile TV signals (e.g., DVB-H, DVB-T, etc.) are received by the receiver 375 through the antenna 385, demodulated, processed and passed to the Mobile TV Baseband 371. Comparing FIG. 3 to FIG. 1, above, it is apparent that neither Mobile TV neither rejection filter 172 nor 173 needs to be included in the RF front-end 304 of Cellular Module 360 when it has the EGSM duplexer 326, according to the depicted embodiment. The EGSM duplexer 326 provides superior filtering with respect to transmitted EGSM signals, thus preventing interference with Mobile TV signals received by the receiver 375. For example, the transmit filter 328 of the EGSM duplexer 326 may provide approximately 34 dB of attenuation in the 470 MHz to 862 MHz band assigned to various types of Mobile TV. In comparison, a DVB-H band rejection filter (e.g., filters 172 and/or 173), for example, provides only about 13 dB in the 470 MHz to 862 MHz band. Further, the insertion loss caused by the EGSM duplexer 326 is typically less than that of the rejection filters 172, 173.

Further, by not including rejection filter 172, in particular (which would otherwise be between the antenna 345 and the switch 339 of RF front-end 304), the insertion loss caused by the rejection filter with respect to DCS band signals is eliminated entirely. This insertion loss would be extraneous since the DCS band signals do not need to be filtered with respect to Mobile TV services. Also, an EGSM duplexer 326 does not need an extra GSM band receive filter.

FIG. 4 is a block diagram illustrating a cellular terminal 400 having Mobile TV module, in accordance with another representative embodiment.

The terminal 400 of FIG. 4 includes two modules, Cellular Module 460 and Mobile TV Module 370. The Mobile TV Module 370 of FIG. 4 may be the same as Mobile TV Module 370 in FIG. 2, and thus the description will not be repeated.

The RF front-end 404 of Cellular Module 460 includes an additional antenna, e.g., antenna 446, dedicated to the DCS band of Cellular Module 460. Incorporation of the antenna 446 reduces insertion loss of the EGSM band signals in Cellular Module 460. The EGSM band signals of Cellular Module 460 are received and transmitted through the antenna 445 via receive filter 427 and transmit filter 428 of duplexer 426, respectively. Inter-module interference between the EGSM band signals of Cellular Module 460 and Mobile TV Module 370 are reduced, as discussed above with respect to duplexer 326 in FIG. 3.

FIG. 5 is a block diagram illustrating a terminal 500 having a Mobile TV Module, in accordance with another representative embodiment. The terminal 500 may be a TDMA wireless communications device operating in a GSM communications system, for example.

As discussed above, the terminal 500 includes two modules, Cellular Module 560 and Mobile TV Module 370, each of which operates on multiple frequency bands, such as in a multi-band GSM system. Cellular Module 560 has a baseband 202 and an RF front-end 504, which communicate IQ symbols, for example, over corresponding I and Q paths, and Mobile TV Module 370 has a baseband 371 and an RF front-end 309. The Cellular Module baseband 202 and the Mobile TV Module baseband 371 may coordinate operations, and interface with the RF front-ends 504, 309, respectively, as well as with various applications of the wireless communications device through inter-module communication.

The RF front-end 504 of Cellular Module 560 includes multi-band transceiver 520. Also, for purposes of explanation, the multi-band transceiver 520 is shown to include an EGSM first band and a DCS second band. It is understood, however, that different numbers and types of frequency bands may be incorporated without departing from the spirit and scope of the various embodiments. The RF front-end 504 further includes an antenna 545, an antenna switch 539, and a dual band power amplifier 522. The dual band power amplifier 522 includes a first amplifier 523 for amplifying EGSM transmit signals and a second amplifier 524 for amplifying DCS transmit signals. The switch 539 may be a SP4T switch, serving as a T/R switch for each band.

The switch 539 selectively connects the EGSM band signals and the DCS band signals to the antenna 545 for communication over the wireless network. For example, the switch 539 connects EGSM band transmit signals received from the first amplifier 523 and an EGSM power amplifier transmit filter 528 to the antenna 545, and connects DCS band transmit signals received from the second amplifier 524 to the antenna 545. Receive signals received by the antenna 545 are passed to the switch 539, which connects EGSM band receive signals to an EGSM receive filter 527 and DCS band receive signals to a DCS receive filter 537.

The EGSM transmit filter 528 is an additional filter, not part of conventional systems. Typically, although embedded LC (inductor/capacitor) filters may be included in transmit paths of a T/R switch, such filters reduce harmonic interference (e.g., second and third harmonics). In contrast, the transmit filter 528 in accordance with the depicted embodiment, reduces interference signals, such as transmit noise leakage, in corresponding receive bands. That is, the EGSM transmit filter 528 reduces noise leakage in the EGSM receive band. The EGSM transmit filter 528 also reduces noise leakage in the Mobile TV receive band, as well. The transmit filter 528 may cause at least 10 dB attenuation in the Mobile TV receive band, for example, although exact attenuation requirements may vary depending on physical implementations. Mobile TV Module 370 of FIG. 5 may be the same as Mobile TV Module 370 in FIG. 2. Accordingly, the description will not be repeated.

In an embodiment, the EGSM transmit filter 528 may be implemented using transmit filter 428 of duplexer 426 in FIG. 4, for example, by grounding the receive filter 427 of the duplexer 426. Likewise, the EGSM receive filter 527 may be implemented using the receive filter 427 of the duplexer 426, for example, by grounding the transmit filter 428.

Referring to the RF front-end 504 of Cellular Module 560, transmit signals from the transceiver 520 are amplified by one of the EGSM amplifier 523 or the DCS amplifier 524 of the dual band power amplifier 522, and pass through the EGSM transmit filter 528 or, in an embodiment, a DCS transmit filter (not shown), depending on the band. The switch 539 connects to the appropriate transmit filter or power amplifier 522, and provides the transmit signals to the antenna 545 for transmission. Receive signals pass through the antenna 545, the switch 539, and one of the EGSM receive filter 527 or the DCS receive filter 537, depending on the band, to the transceiver 520. The transmit filter 528 passes the transmitted EGSM band signal with minimal attenuation, but provides high attenuation of signals generated in the receive band of Mobile TV Module 370, e.g., to prevent “desensing.”

The filters in Cellular Module 560 of FIG. 5 may be implemented, for example, as SAW filters, without departing for the spirit and scope of the depicted embodiments. Further, it is understood that various combinations of components may be implemented as a single chipset, e.g., to save cost and space, with respect to each of the various embodiments described herein. For example, the antenna switch 539 may be combined into a chipset with the antenna 545, the power amplifier 522, the transmit filter 528 and/or the receive filters 527 and 537.

As described above, inter-module interference within a multi-modular terminal is reduced by incorporation of duplexers and/or filters within the corresponding modules, as well as having at least one independent antenna for each module. In various embodiments, the duplexers may replace the antenna (T/R) switches of the conventional systems. Also, in various embodiments, the multi-modular terminal may include a Mobile TV module.

In connection with illustrative embodiments, terminals having multiple modules with duplexers are described. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

What is claimed is:

1. A multi-modular terminal device for enabling simultaneous communications over a plurality of wireless networks, the terminal device comprising:
a duplexer connected to a first transceiver corresponding to a first wireless network of the plurality of wireless networks;
a first antenna connected to the first duplexer for receiving and sending first signals to and from the first transceiver; and
a second antenna, connected to a second receiver corresponding to a second wireless network of the plurality of wireless networks, for receiving second signals to the second receiver;
wherein the duplexer reduces interference to the second signals caused by the receiving and sending of the first signals.

2. The terminal device of claim 1, wherein the second receiver comprises a Mobile TV receiver and the second signals comprise Mobile TV signals.

3. The terminal device of claim 2, wherein the Mobile TV signals comprise one of digital video broadcasting-handheld (DVB-H) signals and digital video broadcasting-terrestrial (DVB-T) signals.

4. The terminal device of claim 3, wherein the first transceiver comprises a dual-band GSM transceiver.

5. The terminal device of claim 4, wherein a first band of the dual-band GSM transceiver comprises an extended GSM (EGSM) band and the first signals comprise EGSM signals.

6. The terminal device of claim 5, wherein a second band of the dual-band GSM transceiver comprises a Digital Communication System (DCS) band.

7. The terminal device of claim 6, wherein the duplexer filters the EGSM signals to reduce interference with the Mobile TV signals.

8. The terminal device of claim 2, further comprising:
a power amplifier connected between the duplexer and the first transceiver, the power amplifier amplifying the first signals sent from the first transceiver for transmission over the first network.

9. The terminal device of claim 8, wherein the duplexer comprises a transmit filter for filtering the first signals received from the first power amplifier and a receive filter for filtering the first signals received from the first antenna.

10. A terminal for simultaneously communicating over a plurality of wireless networks, the terminal comprising:
a first module comprising a dual-band transceiver, a duplexer for duplexing receive and transmit signals in a first band, a filter for filtering receive signals in a second band, a dual-band power amplifier for amplifying transmit signals in the first band and the second band, and at least one first antenna for communicating signals in the first band and the second band of the first module; and
a second module comprising a Mobile TV receiver for receiving receive signals in a Mobile TV band and a second antenna for communicating signals in the Mobile TV band,
wherein the duplexer reduces inter-module interference in the Mobile TV band caused by at least the transmit signals of the first band.

11. The terminal of claim 10, wherein the duplexer comprises a transmit filter for attenuating noise in the first band, preventing interference with at least receive signals in the Mobile TV band.

12. The terminal of claim 11, wherein the Mobile TV signals comprise one of digital video broadcasting-handheld (DVB-H) and digital video broadcasting-terrestrial (DVB-T) signals.

13. The terminal of claim 11, wherein the Mobile TV band comprises a band within a range of 470 MHz to 862 MHz.

14. The terminal of claim 13, wherein the first band comprises an extended GSM (EGSM) band.

15. The terminal of claim 14, wherein the second band comprises a Digital Communication System (DCS) band.

16. The terminal of claim 15, further comprising:
a transmit/receive switch for selectively connecting the receive and transmit signals in the EGSM band to the duplexer, the receive signals in the DCS band to the filter and the transmit signals in the DCS band to the dual-band power amplifier.

17. The terminal of claim 16, wherein the at least one first antenna comprises an EGSM antenna for communicating signals in the EGSM band and a DCS antenna for communicating signals the DCS band.

18. The terminal of claim 15, wherein the filter comprises a surface acoustic wave (SAW) filter.

19. The terminal device of claim 10, wherein the plurality of wireless networks comprise Time Division Multiple Access (TDMA) networks.

20. A system communicating over a plurality of wireless networks using a multi-modal terminal, the system comprising:
a Mobile TV module configured to communicate television signals in a Mobile TV band, the Mobile TV module comprising a receiver and a Mobile TV antenna for receiving receive signals in the Mobile TV band; and
a GSM module configured to communicate extended GSM (EGSM) signals in an EGSM band and Digital Communication System (DCS) signals in a DCS band, the GSM module comprising a multi-band transceiver, a duplexer for duplexing transmit signals in the EGSM band, a dual-band power amplifier for amplifying transmit signals in the EGSM band and the DCS band, a GSM antenna for sending transmit signals in at least one of the EGSM band and the DCS band, and a switch for selectively connecting the duplexer to the GSM antenna for sending the transmit signals in the EGSM band and selectively connecting the power amplifier to the GSM antenna for sending the transmit signals in the DCS band;
wherein the duplexer attenuates noise caused by transmit signals in the EGSM band, reducing interference to receive signals in the Mobile TV band.
